(19) United States
(12) Patent Application Publication
(10) Pub. No.: US 2021/0274820 A1
(43) Pub. Date: Sep. 9, 2021

(54) Processing Technology of Double Stuffed Olives with Garlic and Jalapeno Pepper

(71) Applicant: DEAS S.A. Olives Processing-Packing & Exporting, Halkidikis (GR)

(72) Inventor: Pavlos Deas, Halkidikis (US)

(73) Assignee: DEAS S.A. Olives Processing-Packing & Exporting, Halkidikis (GR)

(21) Appl. No.: 17/329,417

(22) Filed: May 25, 2021

(30) Foreign Application Priority Data
Nov. 1, 2018 (GR) 20180100492

(51) Int. Cl. A23L 19/00; A23L 5/20; A23B 7/10; A23B 7/157; A23B 7/04; A23P 20/25

(52) U.S. Cl. CPC A23L 19/05; A23L 5/276; A23B 7/10; A23V 2002/00; A23B 7/04; A23P 20/25; A23B 7/157

(57) ABSTRACT

The present invention relates, to the process of producing complexly flavored olives which comprise, briefly, the steps of processing the olives before their stuffing and final packing and enhancing the flavor of the vegetables used for stuffing with a brine solution including the parent Olive brine. The parent brine is retrieved from the olive fermentation process, is present in an amount ranging between 40 and 50% and is used at multiple process steps. It is an object of the present invention, to produce a new type of Olives, with a double stuffing of vegetables, in particular, Garlic and Jalapeno Pepper. This process aims the improvement and balancing of the flavors as to the present day, the common methods of production of stuffed olives, include each semi-processed vegetable to be placed directly on the olive without any treatment to improve the flavor.

### CROSS-REFERENCE TO RELATED APPLICATIONS

This Non-Provisional Utility Application claims the benefit of and priority to PCT Application Serial No. PCT/GR2019/000075, filed Oct. 31, 2019, entitled “PROCESSING TECHNOLOGY OF DOUBLE STUFFED OLIVES WITH GARLIC AND JALAPENO PEPPER,” which claims the benefit of and priority to Greek Patent Application Serial No. 20180100492, filed Jan. 11, 2018, entitled “PROCESSING TECHNOLOGY OF DOUBLE STUFFED OLIVES WITH GARLIC AND JALAPENO PEPPER,” the entire contents of both application are incorporated herein by reference.

### TECHNICAL FIELD

This invention is related to the manufacture of stuffed olives with two (2) types of vegetables, by means of a special production process involving both the stage of the enhancement of the olives flavor with a long stay in parent brine and, the strengthening of the vegetable flavor with a brine solution, including the parent brine of olives. Similar Brining of vegetables, is used to bring about certain desired properties.

### BACKGROUND

A wide variety of commercially available edible olive styles are available by using various combinations of curing methods and other treatment steps and the differences between them are mainly based on the variety and type of olives, and not, their filling. With the usual production process followed until now, each vegetable to be filled, is placed directly in the olive without its prior processing, which is related to the improvement and balance of flavors.

### SUMMARY

The object of this invention is to create a new method of manufacturing stuffed olives, which will result in the preparation of a unique taste that is combined with that of garlic and Jalapeno pepper to highlight the individual characteristics of the above in a perfectly fermented product.

After proper treatment of the above olives, garlic, and jalapeno peppers, the taste of the stuffing materials, i.e. garlic and jalapeno peppers, will be further enhanced with olive fermentation brine.

The advantage of this patent, compared to the usual production process of stuffed olives, is that it is possible to produce a new type of stuffed olives with a double filling of vegetables, namely with garlic and jalapeno pepper, the taste of which has been improved and

balanced, while the final olive products have appealing organoleptic properties, desirable appearance and adequate shelf life of twelve months in the marketplace without heat treatment.

### BRIEF DESCRIPTION OF THE DRAWINGS

FIG. 1, provides a flow chart schematic depicting the method for producing double stuffed garlic and Jalapeno Olives. The olives undergo alkaline treatment with sodium hydroxide, which is following by 2 water washings of the fruit, to remove the residual of the lye. The olives then transferred to the tanks where lactic fermentation process occurs. Olives stored in parent brine until pitting and stuffing process. After stuffing with flavored garlic and flavored jalapeno peppers, the olives are preserved in several bulk plastic containers, bulk tins or glass containers and are filled with brine that contains pH regulators and sea salt. Pasteurization process is used to stabilize the product microbiologically and to extend the shelf life.

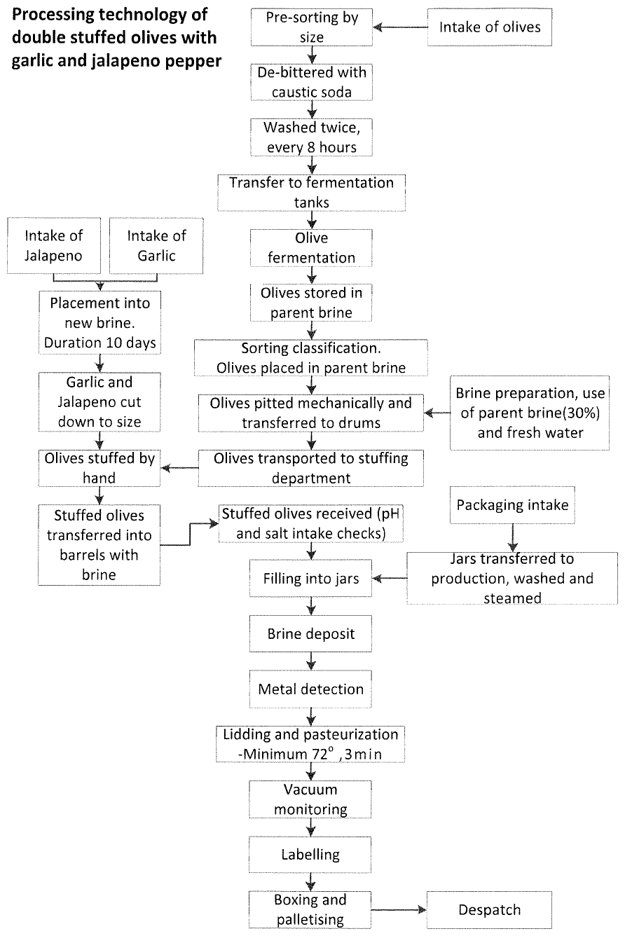

### DETAILED DESCRIPTION

The reception stage of the fermented olive (semi-finished product) is the initial phase in the production process before the filling.

The Processing and product stabilization of the olives is the main phase of the production process, resulting in semi-finished products stored ambient or finished products to be dispatched. At the end of the Sorting calibration stage of olives, the barrels classified by the size and quality categories of olives. The olives shall be transferred into the main Production section of Bulk Products.

The operating stage ‘Processing and product stabilization’, is that of pitting the olives and their stabilization. Specifically, at the end of the pitting process, the olives are placed inside containers with the aid of conventional procedures and controls, adding to said containers brine, with a salt concentration of 7-9% and low PH (high acid), given that, as it has been stated above, the stabilization of the finished product and its release for stuffing process To the above described processes there is a simultaneous distribution of brine. This is a critical control point related to product safety and an integral part of the process. The initial brine for semi-finished or finished products is prepared in stainless tanks with an integrated stirring system, in the main production area. The brine ingredients are water, salt, citric acid, lactic acid, ascorbic acid in quantities according to the maximum permitted level in certain foodstuffs. The final PH is 3.60-4.00.

Pitted Green Olives Stuffing Method with Garlic and Jalapeno Pepper

The method to be used, as stated above, relates to a double filling of olives with vegetables. The filling is performed by hand, with first the pepper ribbon and then the garlic clove. The diameter of the hole of the olives used for filling is between 8.5 and 10 mm on average.

Also, further processing of the filling materials becomes necessary so that each filling retains its organoleptic characteristics to the full, always aiming for the excellent quality and safety of the product, which is related to both microbiological and physicochemical parameters.

The Processing of stuffed olives is done manually. Raw materials, once checked for their suitability, are sent for further processing (stuffing). It is therefore imperative that appropriate working instructions are distributed to the stuffing personnel, to ensure full compliance with the specifications. The olives sizes, product dimensions, and physicochemical characteristics are pre specified, to achieve the optimum organoleptic characteristics of the final product and to avoid products without their filling.

### Specifications Raw Materials and Olives Green Olives Dispatched for Stuffing

| | | | SALT | ACIDITY EXP. |
|---|---|---|---|---|
| OLIVE SIZE | P/KG | PH | CONTENT | LACTIC ACID |
| Super Super | 70-90 | 3.50-4.10 | 7-9% | >0.4% |
| Mammoth | | | | |
| Super Mammoth | 91-100 | 3.50-4.10 | 7-9% | >0.4% |
| Mammoth | 101-110 | 3.50-4.10 | 7-9% | >0.4% |
| Super Colossal | 111-120 | 3.50-4.10 | 7-9% | >0.4% |

### Microbiological Parameters of Green Olives Dispatched for Stuffing

| PARAMETER | LIMIT | UNIT |
|---|---|---|
| TOTAL MESOPHILIC FLORA | <1 × 10\hat{ }6 | cfu/g |

| | | |
|---|---|---|
| YEASTS AND MOLDS | <1 × 10\hat{ }5 | cfu/g |
| COLIFORMS/E. COLI | <10 | cfu/g |
| S. AUREUS | <10 | cfu/g |
| SALMONELLA SPP | Absent | 25 g |
| LISTERIA MONOCYTOGENES | Absent | 25 g |

### 2. Garlic Technical Specification

The Garlic, used for olives stuffing is derived from the fermentation and acidification process. This procedure includes the following steps: fresh garlic receipt, visual inspection, and sorting, blanching, cooling, peeling, cut down to the desired size, washing, salting, and acidification. The acidity correction is achieved with the addition of citric acid. The garlic is placed in a brine consisting of water, salt, and citric acid. The Procedure lasts 10 days and ends when PH reaches the range of 4.1-4.2 and the salt concentration of 19-22%.

Further processing of garlic becomes necessary, as the high salt content for preservation and shelf life extension makes it inedible. To balance the taste of garlic with the olives and the Jalapeno peppers, a brine consisting of 40% filtered parent brine and freshwater is prepared as a product of the olives fermentation. The Acidity is adjusted with lactic acid. Alternatively, citric acid or acetic acid may be used. Garlic is kept in the new brine solution for at least 10 days to improve the organoleptic characteristics.

### Finished Product Attributes: Garlic

Ingredients: Garlic, Water, Salt, Lactic acid, Citric acid

| | |
|---|---|
| Color | White |
| Texture | Firm to bite |
| Shape | Uniform |

| | Garlic | | Salt | Acidity Exp. |
|---|---|---|---|---|
| Olive size | pieces/kg | PH | content | Lactic acid |
| Super Super | 800-1000 | 3.00-3.80 | 8-12% | >0.5% |
| Mammoth | | | | |

| | | | | |
|---|---|---|---|---|
| Super Mammoth | 800-1000 | 3.00-3.80 | 8-12% | >0.5% |
| Mammoth | 800-1000 | 3.00-3.80 | 8-12% | >0.5% |
| Super Colossal | 800-1000 | 3.00-3.80 | 8-12% | >0.5% |

### Microbiological Parameters of Garlic as Stuffing

| PARAMETER | LIMIT | UNIT |
|---|---|---|
| TOTAL MESOPHILIC FLORA | <1 × 10\hat{ }4 | cfu/g |
| YEASTS AND MOLDS | <10\hat{ }3 | cfu/g |
| COLIFORMS/E. COLI | <10 | cfu/g |
| S. AUREUS | <10 | cfu/g |
| SALMONELLA SPP | Absent | 25 g |
| LISTERIA MONOCYTOGENES | Absent | 25 g |

### Jalapeno Pepper—Technical Specification

Jalapeno peppers are fermented. The stages of production include the reception and visual inspection of fresh peppers, the washing, the placing in barrels, the brine addition (the brine consists of: water, salt, and lactic culture). The fermentation lasts up to 8 weeks. Acidity is monitored at all stages of the production process and corrected by acetic acid.

At the end of the fermentation, the product is cut down to the desired size and the brine is added again with the following consistency: Water, Salt, Calcium chloride, potassium metabisulfite. The latter, helps to preserve the color of the product. PH is equilibrated in the range of 3.10-3.60 and the salt content at 4%-6%. The sulfite concentration at this stage is at a maximum of 100 mg/kg. At this point, the product may be preserved for 12 months, ambient. Acidity is monitored at all stages of the production process and corrected by acetic acid.

Further processing of the Jalapeno pepper is necessary, to balance the taste of the pepper with the olives. Before filling the olives, a brine consisting of 50% filtered parent brine—as a product of the fermentation of the olives—and freshwater is prepared. Citric acid or acetic acid may be used to correct the acidity.

The preparation of the second brine may well hide a good manufacturing practice as it targets to totally remove sulphites from final product by reaching a Sulphite concentration less than 10 mg/kg. As well known, sulfites can cause allergy-like symptoms resulting in itching, redness, itching, possible swelling of the tongue and then, depending on the severity, onset of hives or asthma attack.

The use of 50% of the parent brine of olives contributes to achieving the ideal organoleptic characteristics of the jalapeno peppers for olive filling. The retention of the product in this new brine solution is 10 days so as to develop the flavor profile and improve organoleptic properties.

### Finished Product Attributes: Jalapeno Pepper Prior Stuffing Ingredients:

Jalapeno peppers, water, acetic acid, Salt.

| | |
|---|---|
| Colour | Green, Olive Green |
| Texture | Firm to the bite |
| Shape | Uniform |
| Length | 7-9 cm (initial) |
| Diameter | 7-9 mm (after cut) |

| | Cut Pepper | | Brine Salt | Scoville |
|---|---|---|---|---|
| Olive Size | Length | PH | Content | Units |
| Super Super | 2.5-3.0 cm | 3.20-3.50 | 4-6% | 5000-12.000 |
| Mammoth | | | | |
| Super Mammoth | 2.5-3.0 cm | 3.20-3.50 | 4-6% | 5000-12.000 |
| Mammoth | 2.0-2.5 cm | 3.20-3.50 | 4-6% | 5000-12.000 |
| Super Colossal | 1.9-2.2 cm | 3.20-3.50 | 4-6% | 5000-12.000 |

The Jalapeno pepper pungency is rated in terms of ‘Scoville heat units” and is up to the point that is well accepted by consumers that prefer spicy products.

### Microbiological Properties Jalapeno Pepper Prior Olive Stuffing

| PARAMETER | LIMIT | UNIT |
|---|---|---|
| TOTAL MESOPHILIC FLORA | <1 × 10\hat{ }4 | cfu/g |
| YEASTS AND MOULDS | <500 | cfu/g |
| COLIFORMS/E. COLI | <10 | cfu/g |
| S. AUREUS | <10 | cfu/g |
| SALMONELLA SPP | Absent | 25 g |
| LISTERIA MONOCYTOGENES | Absent | 25 g |

All the requirements related to the production process as well as technical and functional aspects of the products need to be maintained as any change in texture, product dimensions may result in loss of stuffing on final product specifically after Thermal process. In addition, If left unchecked, mistakes in the product manufacturing process can lead to food safety and quality issues especially when packed in bulk containers (with no heat treatment).

### APPENDIX 1

Specifications and Standards for Food Additives used for Brine preparation
1. SEA SALT (Brine preparation): quantum satis (Sodium Chloride (Dry): 97%, Water Insoluble: 0.02% Max (ref. to Food and Drinks Code Article 38)
2. LACTIC ACID (as a food preservative, curing agent, and flavoring agent. It is an ingredient in Brine and is used in olive fermentation process and other brine preparation steps): quantum satis (usual dosage: 0.5-1%)
3. ASCORBIC ACID (Antioxidant): quantum satis
4. CITRIC ACID (in Brine): quantum satis
5. WHITE VINEGAR (liquid form, ref. to Food and Drinks Code Article 39).

### APPENDIX 2

Thermal Destruction of Microorganisms Pasteurization of Double Stuffed Olives with Garlic and Jalapeno Pepper

The Inti. Olive Council published minimum required F process values for thermal processing of different types of olives (IOC 2004). The F z T value of a thermal process (or simply F) is defined as the time in minutes at a constant temperature, T, required to destroy a given percentage of microorganisms whose thermal resistance is characterized by z, or, as the equivalent processing time of a hypothetical thermal process at a constant temperature that produces the same effect as the actual thermal process.

Thus, for olives using heat treatment to attain microbial stability, a pasteurization process with an equivalent F5.25° C. 62.4° C. value of at least 15 min is suggested. The above required F process value, termed by IOC (2004) as pasteurization units (PU5.25° C. 62.4° C.), refers to propionic bacteria, characterized by a z-value of 5.25° C., as the reference microorganisms. The D value is a measure of the heat resistance of a microorganism

It is the time, in minutes, at a given temperature required to destroy 1 log cycle (90%) of the target microorganism. In a simulated case, with initial microbial population of lactic acid bacteria 1000000 cfu/g, based on multiple experimental results that were employed, The target group of microorganisms are: Lactobacillus, Leuconostoc (D65=1 min)

For example, a D value at 65° C. of 1 minute means that for each minute of processing at 65° C. the bacteria population of the target microorganism will be reduced by 90%.

That means that the following pasteurization process would have to be applied:
65° C., for 6 min at cold spot
70° C., for 1 min at cold spot
72° C., for 14 sec at cold spot.

### F-Value Calculation

The calculation of the F-value of the process is based on the classical thermobacteriological approach (Ball and Olson 1957).

The basic purpose is to make the product meet a certain quality standard; therefore the following pasteurization process is applied:

−72° C., for 3 min at cold spot

To achieve food safety and extended shelf life, these pasteurization conditions may be applied only if the above mentioned specifications of all materials used, in terms of PH and Salt are in compliance.

Cleaning and disinfection programs for optimal hygiene conditions ensure that all parts of the equipment and food contact surfaces are appropriately clean, for minimization of the initial microbial load.

### APPENDIX 3

### Final Product Specification—Product Packed in Bulk Drums 220 Lt Capacities

| | % IN FINAL PRODUCT |
|---|---|
| INGREDIENTS | (include E No.) |
| GREEN OLIVES | 42.6 |
| WATER | 38.16-39.16 |
| GARLIC | 11-12 |
| GREEN JALAPENO | |
| SEA SALT | 5.8 |
| LACTIC ACID | 0.72 |
| CITRIC ACID | 0.72 |

Organoleptic properties (color, flavor, odor, texture): typical of the variety

Fruit, not damaged or affected by insects,

larvae etc. (in accordance with the relevant legislative requirements) and in particular:

Brine acidity exp. In lactic acid>0.45%

Brine salt content: Green Olives 7° Be-9° Be

PH value: Green Olives: 3.50-4.10

Heavy Metals: In compliance to relevant legislation

Pesticide residues: In compliance to relevant legislation

Microbiological parameters:

O.M.X. (Total [Plate Count)<1-10⁶ cfu/g,

Escherichia coli: <10 cfu/g,

Staphylococcus aureus <10 cfu/g,

Yeast—Molds <1′10^{s} cfu/g

Salmonella spp: Absent/25 g

Listeria monocytogenes: Absent 25 g

Shelf life: 12 months

The product is preserved for 12 months, and is ready to be dispatched for consumption. Alternatively, it is transferred to the pasteurization department for thermal process. Product can be preserved for up to 36 months, ambient.

### APPENDIX 4

### Final Product Specification—Pasteurized Product Packed in 1 Lt Capacity Jars

| INGREDIENTS | % FINAL PRODUCT |
|---|---|
| GREEN OLIVES | 47% |
| WATER | 35.56% |
| GARLIC | 7%-5% (stuffing |
| GREEN JALAPENO | percentage |
| SEA SALT | 4.0 |
| LACTIC ACID (E270) | 0.72 |
| CITRIC ACID (E330) | 0.72 |

| INGREDIENTS | % FINAL PRODUCT |
|---|---|
| GREEN OLIVES | 47% |
| WATER | 35.85% |
| GARLIC | 7%-5% (stuffing |
| | percentage |
| GREEN JALAPENO | 5.0 |
| WHITE VINEGAR | 0.1 |
| HERBS EXTRACT | 0.05 |

Organoleptic properties (color, flavor, odor, texture): typical of the variety

Fruit, not damaged or affected by insects,

larvae etc. (in accordance with the relevant legislative requirements) and in particular:

Brine acidity exp. In lactic acid>0.45%

Brine salt content %: Green Olives 4° Be 5.5° Be

PH value: Green Olives: 3.50-4.10

Heavy Metals: In compliance to relevant legislation

Pesticide residues: In compliance to relevant legislation

Microbiological parameters:

O.M.X. (Total Plate Count)<100 cfu/g,

Escherichia coli: <10 cfu/g,

Staphylococcus aureus <10 cfu/g,

Yeast and Molds <10 cfu/g

Salmonella spp: Absent/25 g

Listeria monocytogenes: Apousia/25 g

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of preparing stuffed olives with double filling of vegetables, including garlic and Jalapeno pepper, preserved for at least 12 months without heat treatment to enhance the taste of all ingredients by using a percentage of olive brine in stages of the production process, the method comprising:
debittering with the immersion of the olives in lye;
removing the lye from the olives;
washing the olives with water to remove excess of lye; and
preserving the olives at an end of a fermentation process for at least 24 months, in which the olives are preserved in their parent brine derived from the fermentation process with a high salt content of 7%-9% and high acidity, up to a size calibration stage before a pitting process and stuffing.

2. The method of claim 1, further comprising a simultaneous distribution of brine, consisting of 30% of a parent olive brine, after a size sorting stage.

3. The method of claim 2, wherein the brine ingredients include water, salt, citric acid, lactic acid, ascorbic acid in quantities according to the maximum permitted level in certain foodstuffs, wherein a final PH is 3.60-4.00.

4. The method of claim 3, wherein use of preserved garlic in the brine that consists of water, salt, and citric acid, in which a PH of garlic is 4.1-4.2 and a salt concentration is 19-22%.

5. The method of claim 4, further comprising a garlic stuffing designed to complement a flavor balance between a taste of olive and garlic, in which the brine is comprised of 40% filtered parent olive brine, which is a product of the fermentation of the olives and freshwater, wherein an acidity of the brine is adjusted using any one or more of a lactic acid, citric acid, or acetic acid.

6. The method of claim 1, wherein the brine consists of water, salt, calcium chloride, and potassium metabisulfite for the preservation of the pepper, wherein a PH range is 3.1-3.60 and a salt content is 4%-6%, a concentration of sulfites derived from the pepper at this stage is up to a maximum of 100 mg/kg, wherein such treatment enables preservation of the olives for 12 months under ambient conditions.

7. The method of claim 6, further comprising:
preparing, before the olives are stuffed, a new brine of the pepper consisting of 50% filtered parent olive brine derived from the fermentation process and freshwater, the new brine being used to remove sulfites from the olives in a finished product; and
correcting the acidity by applying citric acid to the new brine.

8. The method of claim 7, further comprising:
applying a heat treatment of −72° C., for at least 3 minutes at a cold point of the olives so long as PH levels and salt content are satisfied.
